(19) United States
(12) Patent Application Publication
(10) Pub. No.: US 2026/0035011 A1
(43) Pub. Date: Feb. 5, 2026

(54) METHOD FOR OPERATING A DRIVER ASSISTANCE SYSTEM FOR A VEHICLE, AND DRIVER ASSISTANCE SYSTEM

(71) Applicant: Robert Bosch GmbH, Stuttgart (DE)

(72) Inventors: Jerg Pfeil, Cleebronn (DE); Jochen Wieland, Renningen (DE); Karthik Pandaram, Boeblingen (DE); Thomas Michalke, Weil Der Stadt (DE)

(21) Appl. No.: 19/279,050

(22) Filed: Jul. 24, 2025

(30) Foreign Application Priority Data
Aug. 5, 2024 (DE) 10 2024 207 398.9

(51) Int. Cl. B60W 60/00; B60W 50/00; B60W 50/08; B60W 50/14; G05B 13/02

(52) U.S. Cl. CPC B60W 60/001; B60W 50/0097; B60W 50/085; B60W 50/14; B60W 60/0053; G05B 13/0265; B60W 2050/0031; B60W 2420/403; B60W 2420/408; B60W 2520/105; B60W 2556/40; B60W 2556/50; B60W 2720/106

(57) ABSTRACT

A method for operating a driver assistance system for a vehicle, in particular for an autonomous vehicle. The method includes: recording sensor data relating to a vehicle environment; at least partially on the basis of the sensor data, determining a plurality of actual system variables and respective system limits of the driver assistance system that correspond to the actual system variables; passing the actual system variables and the system limits to a trained AI network model; and at least partially by using the AI network model, determining a predicted overall criticality of a driving situation.

### FIELD

The present invention relates to a method for operating a driver assistance system for a vehicle, to a driver assistance system, and to a computer program for performing the method.

### BACKGROUND INFORMATION

Assessing a criticality of a driving scenario is an important task in driver assistance systems, in particular in autonomous driving. This task involves assessing whether a driving scenario can be handled by a system with its specified capabilities. As a basis for this assessment, each system has a predefined ODD (operational design domain).

Conventional, model-based methods for criticality assessment, which estimate whether specific driving parameters in defined driving scenarios are within the limits defined by the ODD, cannot be extended to complex driving scenarios and cannot make criticality assessments of future driving states a few seconds away in time, which is certainly desirable depending on the assistance task, for example in autonomous driving.

It is an object of the present invention to provide an alternative or improved method for operating a driver assistance system for a vehicle, as well as a driver assistance system and a computer program for performing the method.

### SUMMARY

The object of the present invention may be achieved by means of a method, a driver assistance system, and a computer program of the present invention. Advantageous developments, additional features, and/or advantages of the present invention can be found in the disclosure herein.

It should be noted that all features mentioned in connection with the disclosed method of the present invention may also be embodiments of the disclosed system of the present invention, and vice versa.

According to a first aspect, the present invention provides a method for operating a driver assistance system for a vehicle, in particular for an autonomous vehicle. According to an example embodiment of the present invention, the method comprises the following steps:
S1—recording sensor data relating to a vehicle environment;
S2—at least partially on the basis of the sensor data, determining a plurality of actual system variables and respective system limits of the driver assistance system that correspond to the actual system variables;
S3—passing the actual system variables and the system limits to a trained AI network model;
S4—at least partially by using the AI network model, determining a predicted overall criticality of a driving situation.

According to a further aspect, the present invention provides a driver assistance system. According to an example embodiment of the present invention, the system comprises: an environment detection system; and
a control unit comprising an electronic processor, connected to the environment detection system and designed to perform the method defined above.

Instead of performing the risk assessment by classifying the driving scenario and subsequently determining whether the system is within specified specifications for the given scenario, which can also be referred to as a model-based approach to risk assessment, the method of the present invention takes into account how well the driver assistance system, for example a system for autonomous driving, can handle a given situation overall. For this purpose, according to an example embodiment of the present invention, the plurality of relevant actual system variables are compared with the respective current system limits, wherein the entire functional range of the system can be included. The advantage here is that it takes into account that the system limits can change over time, for example due to a current dynamic scenario or slower-acting effects such as the aging of system components.

The method of the present invention described above avoids disadvantages of the model-based approach, which disadvantages can be seen, for example, in the fact that this approach only takes into account a very specific and thus limited set of scenarios, furthermore cannot be generalized to “intermediate scenarios,” and also does not allow for any predictions for the future.

The method of the present invention also avoids the disadvantage that, in the case of criticality metrics ascertained by model-based methods, the threshold values must be interpreted depending on the scenario due to the lack of generalizability of this approach. For example, the criticality assessment for classic measures such as time to brake (TTB) and time to steer (TTS) depends on the speed: for higher speeds, a short TTB is acceptable if the TTS is still sufficiently long. At lower speeds, the TTS is typically short or even below zero (no collision avoidance by steering), while the TTB is sufficiently long. This difficulty of interpretation is also avoided by the method of the present invention.

The advantages of the method of the present invention also include:
ability to steplessly control subsequent system responses through quantitative assessment of system criticality;
ability to trigger targeted system responses by explicitly taking into account the current system limits;
automatic generation of ground truth;
dynamic development of the driver assistance system over time through learning in a self-supervised approach;
feasibility of early warning and handover functions based on the predictive capabilities of the AI model (e.g. triggering the handover of the driving task to a driver/teleoperator (vehicle control center));
feasibility of monitoring functions to determine the extent to which the driver assistance system reaches its limits, in particular with regard to the requirements of ISO 21448 (SOTIF standard);
improved performance and robustness in comparison to traditional methods;
consideration of multidimensional conditions and variables through the plurality of system variables.

According to an example embodiment of the present invention, the AI network may comprise a first level, in which individual criticalities associated with the actual system variables are determined at least partially on the basis of the respective actual system variables and the associated system limits, and a second level, in which the overall criticality is determined at least partially on the basis of the individual criticalities.

According to an example embodiment of the present invention, the method may comprise the following step:
S5—at least partially by using the AI network model, determining predicted system variables.

Determining the predicted overall criticality in step S4 may be carried out at least partially by using the predicted system variables.

According to an example embodiment of the present invention, the method may comprise the following step:
S6—comparing system variables predicted for a first point in time with actual system variables determined at the first point in time, and training and/or adapting the AI network model at least partially on the basis of the comparison.

In the method of the present invention, the AI network model, which can also be referred to as the actual predictive monitoring model of the driver assistance system, can thus be trained online. The difference between the predicted and the actually arisen system variables (e.g. severity of the system responses) is used to correlate the ground truth (“GT”) with scene properties and system states that are potentially critical. By temporally shifting the GT ascertained in this way, the AI network model can, overall, be enabled to predictively determine the future criticality of a scenario. This goes beyond the approach of a classical feedforward strategy and thus makes new applications in the field of risk-adaptive driving possible.

This approach presented within the scope of the present invention is different from an approach in which an AI network model is focused on specific aspects such as anomalies in the real environment or in the vehicle's environment model, derived from the perception algorithms, as a representation of the real environment.

According to an example embodiment of the present invention, the method may comprise the following step:
S6—comparing system variables predicted for a first point in time with actual system variables determined at the first point in time, and training and/or adapting the AI network model at least partially on the basis of the comparison.

According to an example embodiment of the present invention, the method may comprise at least one of the following steps:
S7a-detecting a deviation between a planned trajectory and an actually driven trajectory, and training and/or adapting the AI network model at least partially on the basis of the comparison;
S7b-detecting an intervention by a human driver in a driving operation, and training and/or adapting the AI network model at least partially on the basis of the intervention.

According to an example embodiment of the present invention, if it is determined that an actually driven trajectory deviates from a planned trajectory and/or that a human driver intervenes in the driving operation, this may be an indication that system limits have been exceeded. By transmitting this information in the form of correction data to the AI network model, the criticality assessment made at the time of trajectory planning and based on the system variables present at that time can be evaluated. In this way, the combination of system variables that were present at the time before the potential exceedance of the system limits can be generalized with regard to the criticality of said system variables. In other words, both the deviations described above between planned and actually driven trajectories, and interventions by a human driver can be understood as correction labels used in the training of the AI network model.

According to an example embodiment of the present invention, the method may comprise the following step:
S8—at least partially on the basis of the overall criticality determined in step S4, executing a first routine.

The first routine may comprise at least one of the following actions: adjusting a trajectory of the vehicle, adjusting an acceleration state of the vehicle, outputting information to a human driver, and/or handing over vehicle control to a human driver.

According to an example embodiment of the present invention, the plurality of actual system variables in step S2 may comprise at least one of the following variables and/or states:
a driving scenario;
a location of the vehicle and/or location information from a digital map, and/or a localization inaccuracy of the location of the vehicle;
a computational load of the driver assistance system or of components of the driver assistance system;
a deceleration state and/or acceleration state of the vehicle;
information regarding the presence of objects in a vehicle environment;
properties and/or features of a traffic infrastructure of a vehicle environment, in particular properties or features of a roadway.

The environment detection system may comprise at least one sensor for recording sensor data relating to a vehicle environment, in particular an optical sensor, a radar sensor, and/or a lidar sensor.

The environment detection system may comprise a GPS module and a digital map.

According to a further aspect, the present invention provides a computer program for performing the method of the present invention disclosed above when the computer program is executed by a control unit of a driver assistance system.

### BRIEF DESCRIPTION OF THE DRAWINGS

The present invention is explained in more detail below using exemplary embodiments with reference to the schematic and not-to-scale figures. The figures (FIG.) are merely exemplary.

FIG. 1 shows a schematic flowchart of an example embodiment of a method for operating a driver assistance system, according to the present invention.

FIG. 2 shows a schematic diagram illustrating system variables and system limits, according to an example embodiment of the present invention.

FIG. 3 shows a schematic architecture of an AI network model, according to an example embodiment of the present invention.

### DETAILED DESCRIPTION OF EXAMPLE EMBODIMENTS

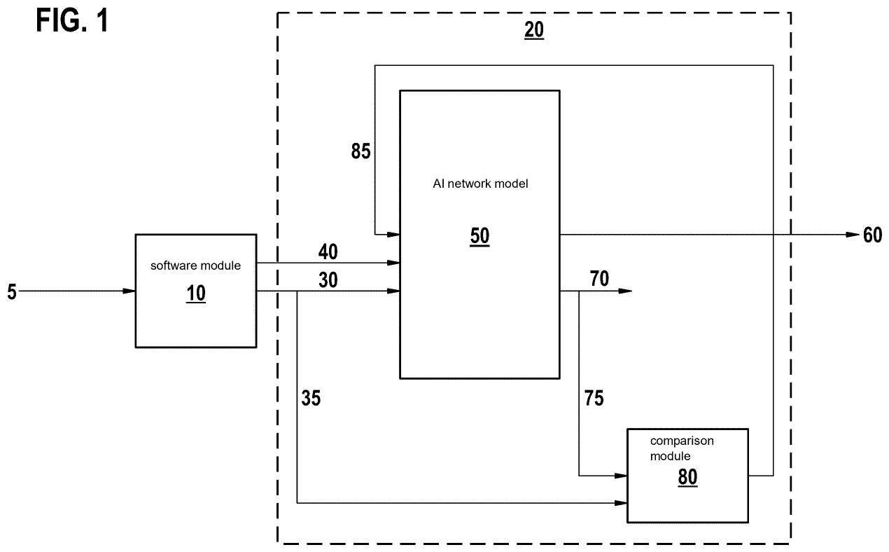

The structure and functioning of a method for operating a driver assistance system are described schematically below using FIGS. 1 to 3. Corresponding reference symbols are used for corresponding features.

FIG. 1 shows a schematic flowchart of an embodiment of the presently disclosed method using the example of a method for operating an autonomous vehicle. In a step S1, sensor data relating to a vehicle environment are recorded at 5 and forwarded to a software module 10. The sensor data 5 may in particular comprise image data recorded by optical sensors such as cameras, but also radar data, lidar data, ultrasound data, and/or position data. The software module 10 comprises all algorithms and routines necessary for the realization of perception, localization, situation interpretation, planning, and control of the driving operation of the autonomous vehicle.

In a step S2, a plurality of actual system variables 30 is determined by the software module 10 and at least partially on the basis of the sensor data 5. The actual system variables 30 may comprise virtually all variables and/or states arising during operation of the vehicle, for example: the driving scenario, the position of the vehicle, position information from the digital map, a localization inaccuracy of the position of the vehicle, a computational load of the driver assistance system or of components of the driver assistance system, information on the deceleration state and/or acceleration state of the vehicle, information regarding the presence of objects in a vehicle environment, as well as properties and/or features of a traffic infrastructure of a vehicle environment, in particular properties or features of a roadway.

These actual system variables 30 are referred to as “actual” within the scope of the present disclosure because they are actually present, within the accuracy of their calculation or determination, at the time the sensor data 5 are recorded, i.e. they are not predicted.

In step S2, respective system limits 40 of the driver assistance system that correspond to the actual system variables 30 are also determined, for example currently achievable longitudinal and/or lateral accelerations, localization accuracies, and so on.

In a step S3, the actual system variables 30 and the system limits are passed to a trained AI network model 50, which is part of a module 20 for predicting an overall criticality of a driving situation. The AI network model 50 is trained, in a step S4 of the method, to determine a predicted overall criticality of the driving situation at least partially on the basis of the actual system variables and the system limits, and to output a corresponding criticality metric 60. The criticality metric 60 therefore represents a criticality that is expected by the module 20 at a future point in time, which means that this is a criticality prediction. The time interval between the current driving situation and the point in time at which the predicted criticality is expected can be in the order of magnitude of fractions of a second up to several seconds.

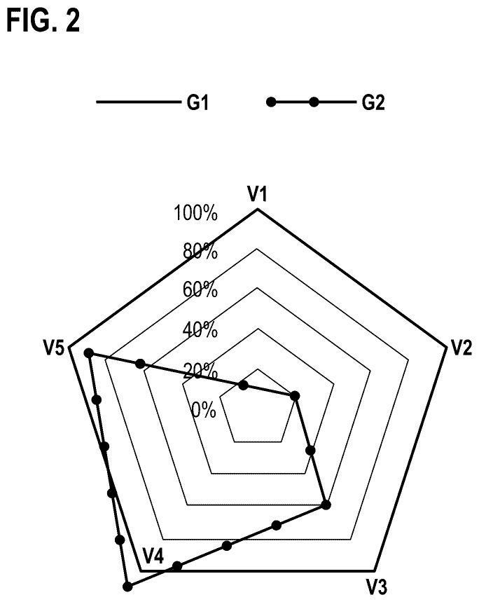

In embodiments of the method, the AI network model 50 determines, in a step S5, predicted system variables, i.e. system variables that are expected at a future point in time. This is indicated at 70 in FIG. 1. The predicted system variables can advantageously be used to determine the predicted overall criticality, as further described in connection with FIG. 2.

As explained above, in the presently disclosed method, a plurality of relevant internal system variables are compared with the respective current system limits, i.e. the entire functional range of the driver assistance system is potentially included. For illustrating the procedure, FIG. 2 shows a multidimensional space, which is spanned by a set of system variables V1 to V5 in the example. For example, V1 may be a metric for longitudinal acceleration, V2 may be a metric for road width, V3 may be a metric for the probability of the presence of neighboring objects, and so on. In this space, a graph G1 represents the system limits corresponding to the system variables and thus corresponds to values of 100% in the coordinates spanned by the system variables.

The graph G2 shows predicted values of the system variables that correspond to the system variables V1 to V5 and from whose position in the multidimensional space, illustratively speaking, the overall criticality is determined. It should be noted that, for example, the situation indicated in FIG. 2, in which a predicted system variable at V4 exceeds the corresponding system limit of 100%, may not have a high overall criticality, since the “overall picture” of the driving situation, taking into account the other system variables and their corresponding percentage “exhaustion” of the system limits, is classified as not critical overall.

It should be pointed out that the diagram shown in FIG. 2 is intended only as a schematic representation illustrating that the AI model 50 is capable of using internal regression methods to predict a combined criticality measure, rather than performing simple threshold-value-based comparisons of individual system variables. In the actual method, however, a diagram as shown in FIG. 2 is usually neither created nor used to determine the overall criticality.

Furthermore, the predicted system variables can be used to improve the AI network model 50, for example to make it more accurate. At 75 in FIG. 1, the predicted system variables are passed for this purpose to a comparison module 80, which, in a step S6, compares the system variables predicted for a first point in time with actual system variables determined at the first point in time. The point in time at which the system variables are predicted is therefore before the first point in time at which the predicted system variables are compared with the actual system variables.

A result of the comparison, i.e. a measure of the agreement between the predicted and the later actual system variables, is transmitted in the sense of a deviation vector to the AI network model 50 at 85, and the algorithm of the AI network model 50 can be trained and/or adapted at least partially on the basis of the comparison. In embodiments of the method, the AI network model 50 operates in a self-supervised manner and is capable of becoming successively more accurate with respect to the actual and the predicted system variables or system limits on the basis of continuously collected data.

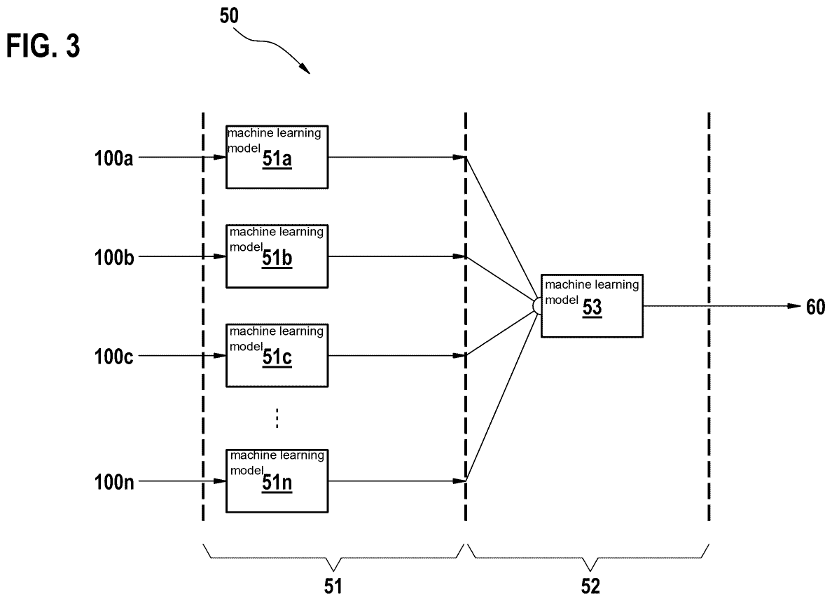

With reference to FIG. 3, the structure of the AI network model 50 is now described in more detail.

As can be seen in FIG. 3, the AI network model 50 comprises a first level 51 and a second level 52. The architecture of the AI network model 50 shown in FIG. 3 can also be referred to as a stacked deep ensemble.

The first level 51 comprises a number n of machine learning models 51a to 51n, which each have a or a subset of actual system variables and system limits such as TTC (time to collision), THW (time head way), and trajectories as input and determine individual criticalities on this basis. The models 51a to 51n of the first level 51 can be both supervised and self-supervised, based on the availability of labels and/or ground truth. The fact that a separate model 51i is used for a specific system variable “i” or a subset of system variables advantageously allows each of these variables to have different sampling rates and frequencies and/or to be dependent on a specific driving scenario. A single model might require resampling of these data, which could result in the loss of data that are crucial for determining the overall criticality.

The predicted individual criticalities of the first level 51 are used, as shown in FIG. 3, as input for a machine learning model 53, which is arranged in the second level 52 and determines the overall criticality of the system at least partially on the basis of these individual criticalities. In embodiments of the method, a machine learning model designed as a meta-learner is used in the second level 52, in comparison to alternative approaches such as majority voting ensembles or weighted average. The machine learning model 53 is based on scenarios, and the weighting of the individual criticalities determined in the first level 51 is thus not hard-coded in the machine learning model 53, but is adapted to the corresponding scenarios.

While the AI model 50 can also process image data, a large portion of the system variables used are time series signals, and it is thus important that the temporal relationship between system variables during normal operation and in critical scenarios is analyzed. The reason for this is that the overall system criticality is also scenario-based, which requires understanding of the temporal relationship between different scenes.

Reference is now made again to the step, shown in FIG. 1 under reference symbol 85, of feeding back deviation values to the AI network model 50, with the aim of demonstrating further possibilities of how the AI network model 50 can progressively improve itself.

The trajectories output by a planner of the vehicle assistance system may deviate from the trajectory actually taken by the ego vehicle. Reasons for such deviations can be quickly replanned trajectories, for example, in order to avoid collisions with dynamic obstacles that may suddenly appear from obscured areas. This deviation between real and actual trajectories can be regarded as a criticality metric, and the detection of such a criticality metric, which can be carried out in a step S7a of the method, is used in embodiments of the presently disclosed method in determining the overall criticality. Since the planner, at any point in time, outputs the planned trajectory for the future, recognizing whether the planned trajectory is feasible or not at the planned point in time inherently also means recognizing the criticality of the system in the future. In this case, the real trajectory is not required at the time of inference by the ML model. Instead, the ML model can predict the labels (system limit violated/not violated) with virtually the same prediction horizon as the motion planner. This means that the real trajectory data are required only for training the AI model 50, which can be carried out by evaluating real trajectories and predicted trajectories. In this case, the input for the ML models during training are deviation values and trajectories planned by the planner. During the inference phase, the planned trajectories are the input values of the model, and the output is the deviation value. The well-known AI architecture LSTM-RNN, for example, can be used advantageously for these applications.

Furthermore, feedback 85 of the AI network model 50 can be derived from interventions by a human driver, which can be carried out in a step S7b of the method. If there is a driver intervention that overrides a driving instruction issued by the driver assistance system, a correction specification for the AI network model 50 can be identified based on the specific type and intensity of the intervention. Relevant system variables in this context are in particular:
steering wheel angle
steering torque
braking torque
desired acceleration (e.g. accelerator pedal position)

By adjusting the parameters of the AI network model 50 on the basis of the above-defined corrective interventions by the driver, the AD driving function can be specifically improved for the particular current scenario (for example, through a reinforcement learning approach).

Depending on the availability of ground truth and labels, and depending on the particular task of regression (i.e. the prediction of the overall criticality metric) or classification (i.e. the detection of a current criticality metric), the machine learning models of the first level 51 can have different architectures. For the task of predicting the overall criticality metric, machine learning architectures from the group comprising LSTM R-NN, Temporal Fusion Transformer, and N-HiTS can be used, for example. Supervised or self-supervising architectures can be used for the task of detecting the current criticality metric. In the field of supervised architectures, architectures from the group comprising LSTM R-NN and Arsenal can be used, for example; in the field of self-supervising architectures, architectures from the group comprising Wave2vec2 and SelfTime can be used.

The present invention is not limited to the described and illustrated exemplary embodiments. Rather, it also includes all expert developments within the scope of the present invention. In addition to the example embodiments described and depicted, further embodiments, which may include further modifications as well as combinations of features, are possible.

1-13. (canceled)

14. A method for operating a driver assistance system for an autonomous vehicle, comprising the following steps:
S1) recording sensor data relating to a vehicle environment;
S2) determining, at least partially based on the sensor data, a plurality of actual system variables and respective system limits of the driver assistance system that correspond to the actual system variables;
S3) passing the actual system variables and the respective system limits to a trained AI network model; and
S4) determining, at least partially by using the AI network model, a predicted overall criticality of a driving situation.

15. The method according to claim 14, wherein the AI network model includes a first level, in which individual criticalities associated with the actual system variables are determined at least partially based on the respective actual system variables and the respective system limits, and a second level, in which the overall criticality is determined at least partially based on the individual criticalities.

16. The method according to claim 14, further comprising the following step:
S5) determining, at least partially by using the AI network model, predicted system variables.

17. The method according to claim 16, wherein determining the predicted overall criticality in step S4 is carried out at least partially by using the predicted system variables.

18. The method according to claim 16, further comprising the following step:
S6) comparing system variables predicted for a first point in time with actual system variables determined at the first point in time, and training and/or adapting the AI network model at least partially based on the comparison.

19. The method according to claim 18, further comprising at least one of the following steps:
S7a) detecting a deviation between a planned trajectory and an actually driven trajectory, and training and/or adapting the AI network model at least partially based on the comparison;
S7b) detecting an intervention by a human driver in a driving operation, and training and/or adapting the AI network model at least partially based on the intervention.

20. The method according to claim 14, further comprising the following step:
S8) executing, at least partially based on the overall criticality determined in step S4, a first routine.

21. The method according to claim 20, wherein the first routine includes at least one of the following actions: adjusting a trajectory of the vehicle, and/or adjusting an acceleration state of the vehicle, and/or outputting information to a human driver, and/or handing over vehicle control to a human driver.

22. The method according to claim 14, wherein the plurality of actual system variables in step S2 includes at least one of the following variables and/or states:
i) a driving scenario;
ii) a location of the vehicle and/or location information from a digital map, and/or a localization inaccuracy of the location of the vehicle;
iii) a computational load of the driver assistance system or of components of the driver assistance system;
iv) a deceleration state and/or acceleration state of the vehicle;
v) information regarding the presence of objects in a vehicle environment;
vi) properties and/or features of a traffic infrastructure of a vehicle environment, including properties or features of a roadway.

23. A driver assistance system, comprising:
an environment detection system; and
a control unit including an electronic processor, connected to the environment detection system and configured to operate a driver assistance system for an autonomous vehicle, by performing the following steps:
S1) recording sensor data relating to a vehicle environment,
S2) determining, at least partially based on the sensor data, a plurality of actual system variables and respective system limits of the driver assistance system that correspond to the actual system variables,
S3) passing the actual system variables and the respective system limits to a trained AI network model, and
S4) determining, at least partially by using the AI network model, a predicted overall criticality of a driving situation.

24. The driver assistance system according to claim 23, wherein the environment detection system includes at least one sensor for recording sensor data relating to a vehicle environment, the at least one sensor including an optical sensor, and/or a radar sensor, and/or a lidar sensor.

25. The driver assistance system according to claim 23, further comprising a GPS module, and a digital map.

26. A non-transitory computer-readable storage medium on which is stored a computer program for operating a driver assistance system for an autonomous vehicle, the computer program, when executed by a control unit of the driver assistance system, causing the control unit to perform the following steps:
S1) recording sensor data relating to a vehicle environment;
S2) determining, at least partially based on the sensor data, a plurality of actual system variables and respective system limits of the driver assistance system that correspond to the actual system variables;
S3) passing the actual system variables and the respective system limits to a trained AI network model; and
S4) determining, at least partially by using the AI network model, a predicted overall criticality of a driving situation.
